(19) United States
(12) Patent Application Publication
(10) Pub. No.: US 2026/0295772 A1
(43) Pub. Date: Oct. 1, 2026

(54) ARTICLE FOR CHEMICAL MECHANICAL POLISHING PROCESS AND CHEMICAL MECHANICAL POLISHING SYSTEM INCLUDING THE ARTICLE

(71) Applicant: SHPP GLOBAL TECHNOLOGIES B.V., Bergen op Zoom (NL)

(72) Inventors: Soonyoung HYUN, Yongin-si (KR); Yanjie SUN, Shanghai (CN); Haekwon KIM, Gunpo-si (KR)

(21) Appl. No.: 19/478,635

(22) PCT Filed: Apr. 26, 2024
(86) PCT No.: PCT/IB2024/054090

§ 371 Date: Oct. 24, 2025

(30) Foreign Application Priority Data
Apr. 28, 2023 (EP) 23170661.5

(51) Int. Cl. B24B 37/32; B29C 45/14; C08L 81/02

(52) U.S. Cl. CPC B24B 37/32; B29C 45/14311; B29C 45/1459; C08L 81/02; C08L 2205/035

(57) ABSTRACT

An article for use in a chemical mechanical polishing process includes a metal backbone and a thermoplastic composition encapsulating the metal backbone. The metal backbone can optionally include a buffer layer between the surface of the backbone and the thermoplastic composition. The metal backbone or, when present, the buffer layer includes a plurality of pores. Methods for the manufacture of the article are also described.

### CROSS-REFERENCE TO RELATED APPLICATION

This application claims priority to and the benefit of European Patent Application No. 23170661.5, filed on Apr. 28, 2023, the contents of which are hereby incorporated by reference in their entirety.

### BACKGROUND

Chemical mechanical polishing (CMP), also referred to as chemical mechanical planarization, refers to a method of removing layers of solid through chemical mechanical polishing carried out for the purpose of surface planarization. In a typical CMP process, a rotating polishing pad uses a chemically reactive slurry to polish the outermost surface of the substrate. The substrate is positioned over the polishing pad and is held in place by a retaining ring. Typically, the substrate and the retaining ring are mounted on a carrier or polishing head. A controlled force is exerted on the substrate by the carrier head to press the substrate against the polishing pad. The movement of the polishing pad across the surface of the substrate causes material to be chemically and mechanically removed from the face of the substrate. The equipment used to perform CMP processes includes various components that are typically required to be replaced with some frequency during a polishing process, which can lead to high costs associated with CMP. One such component is the retaining ring, which as mentioned above, serves to contain the slurry and maintain the position of the substrate that is being polished.

Accordingly, there remains a continuing need in the art for an improved chemical mechanical polishing processes.

### SUMMARY

An article for use in a chemical mechanical polishing process comprises a metal backbone optionally comprising a buffer layer on a surface of the metal backbone, wherein the metal backbone further comprises a plurality of pores on the surface of the metal backbone or, when present, on the buffer layer; and a thermoplastic composition encapsulating the metal backbone.

A method of manufacturing the article comprises providing a metal backbone; optionally, depositing a buffer layer on the metal backbone; surface treating the metal backbone or, when present, the buffer layer, to provide a plurality of pores on the metal backbone or, when present, the buffer layer; and molding a thermoplastic composition onto the surface treated metal backbone to provide the article.

A chemical mechanical polishing system comprises the article.

Another aspect of the present disclosure is a polyphenylene sulfide composition comprising: 5 to 43.9 weight percent of a poly(etherimide-siloxane copolymer); 55 to 85 weight percent of a poly(phenylene sulfide); 1 to 10 weight percent of a polyaryl ether ketone; and 0.1 to 5 weight percent of an epoxy resin; and optionally, 0.1 to 10 weight percent of an additive composition; wherein weight percent is based on the total weight of the thermoplastic composition.

The above described and other features are exemplified by the following figures and detailed description.

### BRIEF DESCRIPTION OF THE DRAWINGS

The following figures are exemplary embodiments wherein the like elements are numbered alike.

FIG. 1 depicts a bottom view of an article ring according to an aspect of the present disclosure.

FIG. 2 is a schematic illustration representing an aspect of the present disclosure.

FIG. 3 is a schematic illustration representing an aspect of the present disclosure.

FIG. 4 is a photograph of a cross section of an article not according to the present disclosure showing delamination from the metal backbone.

FIG. 5 is a photograph of a cross-section of an article according to an aspect of the present disclosure showing no delamination from the metal backbone.

### DETAILED DESCRIPTION

The present inventors have unexpectedly discovered an improved article for a CMP process can be provided when the article includes a plurality of pores on the metal surface of the article. The article can be in the form of a retaining ring for use in a CMP process. Advantageously, use of the particular article described herein can provide a structure having good mechanical strength and improved adhesion between the polymer composition and the metal backbone, resulting in improved flatness and decreased distortion observed in the product. The inventors have also found that further improvements can be provided when a particular polyphenylene sulfide composition is used as a component of the article, even in the absence of nanopores.

Accordingly, an aspect of the present disclosure is an article for use in a chemical mechanical polishing process. In a specific aspect, the article is a retaining ring for use in a chemical mechanical polishing process. The article comprises a metal backbone. The metal backbone can include, for example, aluminum, stainless steel, molybdenum, a ceramic, zinc, or an alloy or combination thereof. In an aspect, the metal backbone can be an annular metal backbone.

The metal backbone can optionally comprise a buffer layer on a surface of the metal backbone. In an aspect, the buffer layer can cover the entirety of the surface of the metal backbone. Stated another way, the buffer layer can encase the metal backbone.

When present, the buffer layer can comprise an inorganic material, an organic material, or a combination thereof. In an aspect, the buffer layer can comprise an inorganic material such as Al₂O₃, TiO₂, ZnO, SiO₂, PbO, Na₂O, CaO, MgO, CuO, or an alloy thereof. In a specific aspect, the buffer layer can comprise Al₂O₃. In an aspect the buffer layer can comprise an organic material such as a thermoset material. Exemplary thermoset materials can include thermoset acrylates, epoxies, polyimides, polyurethanes, or a combination thereof. In an aspect, the buffer layer can comprise a filled thermoset material, wherein the filler is preferably an inorganic oxide, for example Al₂O₃, TiO₂, ZnO, SiO₂, PbO, Na₂O, CaO, MgO, CuO, or an alloy thereof.

The buffer layer, when present, can be deposited by any suitable means which can be determined, for example, based on the chemical composition of the buffer layer. The buffer layer can be deposited in an amount effective to provide a buffer layer having a thickness of 1 micrometer to 1000 micrometers, preferably 1 micrometer to 750 micrometers, 5 micrometers to 750 micrometers, or 5 micrometers to 500 micrometers, or 10 micrometers to 500 micrometers.

The metal backbone further comprises a plurality of pores on the surface of the metal backbone. When the buffer layer is present on the surface of the metal backbone, the plurality of pores are on the outer surface of the buffer layer. In an aspect, no buffer layer is present and the plurality of pores are on the surface of the metal backbone. In an aspect, the buffer layer is present and the plurality of pores are on the outer surface of the buffer layer.

In an aspect, the pores are preferably nanopores. The term “nanopores” as used herein refers to pores having a diameter of 1 nanometer to 100 nanometers. In an aspect, the pores can have a depth of 1 nanometer to 1000 nanometers. In an aspect, the pores can have a diameter of 1 nanometer to 100 nanometers and a depth of 1 nanometer to 1000 nanometers. The pores can be of any suitable shape, which can include regular or irregular shapes, or a combination thereof. For example, the pores can be substantially cylindrical. In an aspect, the pores may be irregular in shape with an average diameter (e.g., measured across the widest dimension of the pore opening on the surface of the metal backbone or the buffer layer) of 1 nanometer to 100 nanometers.

The article according to the present disclosure further comprises a thermoplastic composition encapsulating the metal backbone. The thermoplastic composition comprises a thermoplastic polymer. Exemplary thermoplastic polymers can include a polyetherimide, a poly(phenylene sulfide), a poly(aromatic ketone), a poly(phenylene sulfone), a polycarbonate, a polyester, a polyolefin, or a combination thereof. In an aspect, the thermoplastic composition can comprise a polyetherimide, a poly(phenylene sulfide), a poly(aromatic ketone), a poly(phenylene sulfone), a polyester (e.g., poly(butylene naphthalate)), or a combination thereof.

In an aspect, the thermoplastic composition comprises a polyetherimide. Polyetherimides comprise more than 1, for example 2 to 1000, or 5 to 500, or 10 to 100 structural units of formula (1)

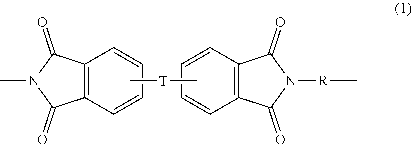

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In an aspect R is divalent group of one or more of the following formulas (2)

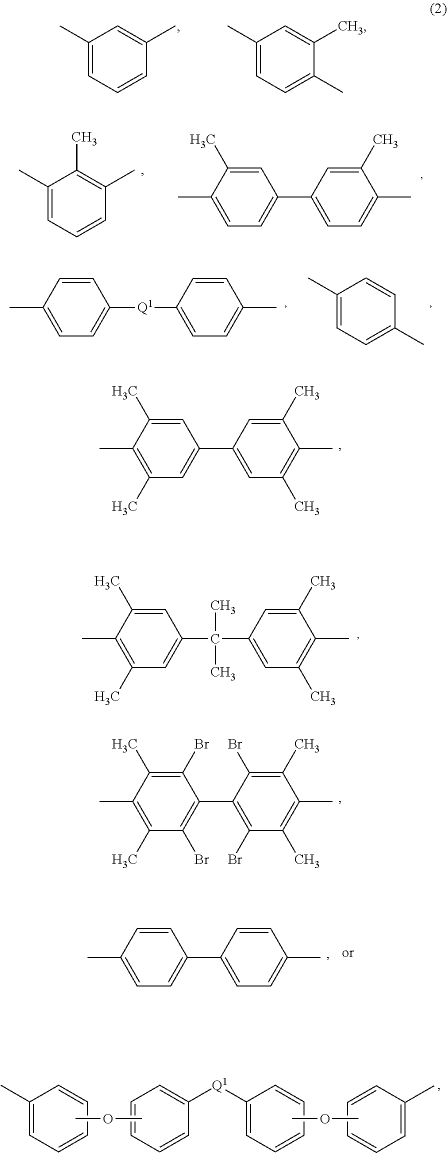

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an aspect R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In an aspect, at least 10 mole percent or at least 50 mole percent of the R groups contain sulfone groups, and in other aspects no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula

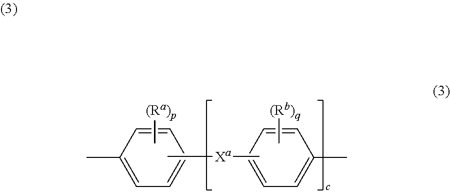

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

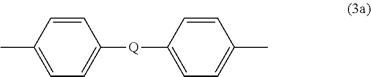

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In an aspect Z is a derived from bisphenol A, such that Q in formula (3a) is 2,2-isopropylidene.

In an aspect in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O— wherein Z is a divalent group of formula (3a) and Q is 2,2-isopropylidene. In an aspect, R is p-phenylene and T is —O—Z—O— wherein Z is a divalent group of formula (3a) and Q is 2,2-isopropylidene. Such materials are available under the trade name ULTEM from SABIC.

In an aspect, the polyetherimide is a copolymer that optionally comprises additional structural imide units that are not polyetherimide units, for example imide units of formula (4)

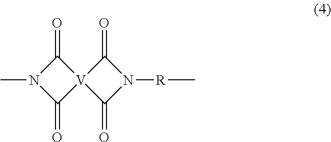

wherein R is as described in formula (1) and each V is the same or different, and is a substituted or unsubstituted C₆₋₂₀ aromatic hydrocarbon group, for example a tetravalent linker of the formulas

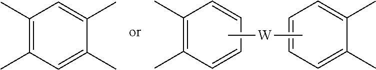

wherein W is a single bond, —O—, —S—. —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In an aspect, no additional imide units are present in the poly(etherimide).

The polyetherimide can be prepared by any of the methods known to those skilled in the art, including the reaction of an aromatic bis(ether anhydride) of formula (5) or a chemical equivalent thereof, with an organic diamine of formula (6)

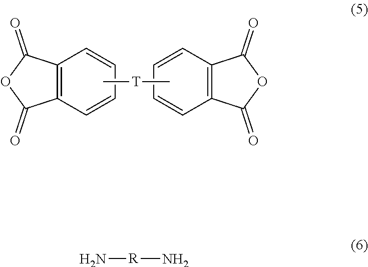

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In an aspect the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The thermoplastic composition can also comprise a poly(etherimide-siloxane) copolymer comprising polyetherimide units of formula (1) and siloxane blocks of formula (7)

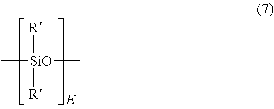

wherein E has an average value of 2 to 100, 2 to 31, 5 to 75, 5 to 60, 5 to 15, or 15 to 40, each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In an embodiment no bromine or chlorine is present, and in another embodiment no halogens are present. Combinations of the foregoing R groups can be used in the same copolymer. In an embodiment, the polysiloxane blocks comprises R′ groups that have minimal hydrocarbon content. In a specific embodiment, an R′ group with a minimal hydrocarbon content is a methyl group.

The poly(etherimide-siloxane)s can be formed by polymerization of an aromatic bis(ether anhydride) of formula (5) and a diamine component comprising an organic diamine (6) as described above or a combination of diamines, and a polysiloxane diamine of formula (8)

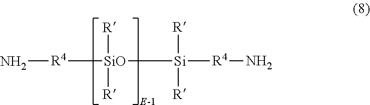

wherein R′ and E are as described in formula (7), and R⁴ is each independently a C₂-C₂₀ hydrocarbon, in particular a C₂-C₂₀ arylene, alkylene, or arylenealkylene group. In an aspect R⁴ is a C₂-C₂₀ alkylene group, specifically a C₂-C₁₀ alkylene group such as propylene, and E has an average value of 5 to 100, 5 to 75, 5 to 60, 5 to 15, or 15 to 40. Procedures for making the polysiloxane diamines of formula (8) are well known in the art.

In some poly(etherimide-siloxane)s the diamine component can contain 10 to 90 mole percent (mol %), or 20 to 50 mol %, or 25 to 40 mol % of polysiloxane diamine (8) and 10 to 90 mol %, or 50 to 80 mol %, or 60 to 75 mol % of diamine (6), for example as described in U.S. Pat. No. 4,404,350. The diamine components can be physically mixed prior to reaction with the bisanhydride(s), thus forming a substantially random copolymer. Alternatively, block or alternating copolymers can be formed by selective reaction of (6) and (8) with aromatic bis(ether anhydrides (5), to make polyimide blocks that are subsequently reacted together. Thus, the poly(etherimide-siloxane) copolymer can be a block, random, or graft copolymer. In an aspect the copolymer is a block copolymer.

Examples of specific poly(etherimide-siloxane)s are described in U.S. Pat. Nos. 4,404,350, 4,808,686 and 4,690,997. In an aspect, the poly(etherimide-siloxane) has units of formula (9)

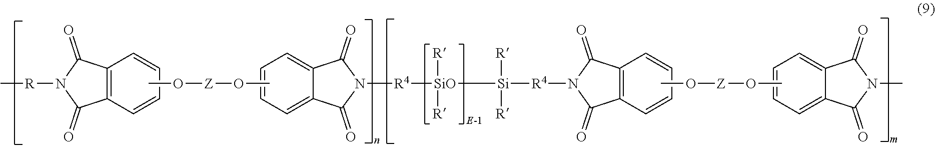

wherein R′ and E of the siloxane are as in formula (7), R and Z of the imide are as in formula (1), R⁴ is as in formula (8), and n and m are each integers greater than 0, and the sum of n and m is 5 to 100. In a specific aspect of the poly(etherimide-siloxane), R of the etherimide is a phenylene, Z is a residue of bisphenol A, R⁴ is n-propylene, E is 2 to 50, 5, to 30, or 10 to 40, n+m is 5 to 100, and each R′ of the siloxane is methyl.

The relative amount of polysiloxane units and etherimide units in the poly(etherimide-siloxane) depends on the desired properties, and are selected using the guidelines provided herein. In particular, as mentioned above, the block or graft poly(etherimide-siloxane) copolymer is selected to have a certain average value of E, and is selected and used in an amount effective to provide the desired weight percent of polysiloxane units in the composition. In an aspect the poly(etherimide-siloxane) comprises 10 weight percent to 50 weight percent, 10 weight percent to 40 weight percent, or 20 weight percent to 35 weight percent polysiloxane units, based on the total weight of the poly(etherimide-siloxane).

The polyetherimide can have a melt index of 0.1 grams per minute to 10 grams per minute (g/min), as measured by American Society for Testing Materials (ASTM) D1238 at 340° C. to 370° C., using a 6.7 kilogram (kg) weight. In an aspect, the polyetherimide has a weight average molecular weight (Mw) of 1,000 grams/mole to 150,000 grams/mole (Dalton), as measured by gel permeation chromatography, using poly(styrene) standards. In an aspect the poly(etherimide) has an Mw of 10,000 Daltons to 80,000 Daltons. Such polyetherimides typically have an intrinsic viscosity greater than 0.2 deciliters per gram (dl/g), or, more specifically, 0.35 dl/g to 0.7 dt/g as measured in m-cresol at 25° C.

In an aspect, the thermoplastic composition of the article comprises a polyphenylene sulfide composition comprising a polyetherimide-siloxane copolymer, a polyphenylene sulfide, a polyaromatic ketone, and an epoxy.

The polyetherimide-siloxane copolymer can be as described above. In an aspect, the polyetherimide-siloxane copolymer can have a siloxane content of 10 weight percent to 30 weight percent, or 15 weight percent to 25 weight percent, or 18 weight percent to 22 weight percent.

The polyaromatic ketone comprises repeating units of formula (10)

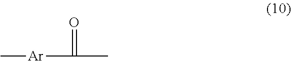

wherein Ar is independently at each occurrence a substituted or unsubstituted, monocyclic or polycyclic aromatic group having 6-30 carbons. Exemplary Ar groups can include, but are not limited to, substituted or unsubstituted phenyl, tolyl, naphthyl, and biphenyl. Unsubstituted phenyl can be preferred. In an aspect, the poly(aromatic ketone) can be a poly(arylene ether ketone) (PAEK) comprising repeating units of formula (10) and formula (12)

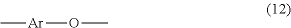

wherein Ar is defined as above. In an aspect the poly(aromatic ketone) comprises a poly(ether ketone). A poly(ether ketone) comprises repeating units of formula (13)

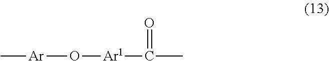

wherein Ar is defined as above and Ar¹ is independently at each occurrence a substituted or unsubstituted, monocyclic or polycyclic aromatic group having 6-30 carbons. Ar can be the same as or different from Ar¹. In an aspect Ar and Ar¹ are phenyl groups, preferably unsubstituted phenyl groups.

In an aspect, the poly(aromatic ketone) comprises a poly(ether ether ketone). A poly(ether ether ketone) comprises repeating units of formula (14)

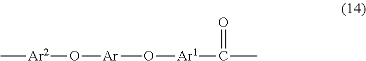

wherein Ar and Ar¹ are defined as above. Ar² is independently at each occurrence a substituted or unsubstituted, monocyclic or polycyclic aromatic group having 6-30 carbons. Ar. Ari, and Ar² can be the same as or different from each other. Additionally, two of Ar, Ar¹, and Ar² can be the same as each other and the third can be different. In an aspect Ar, Ar¹, and Ar² are phenyl groups, preferably unsubstituted phenyl groups.

Poly(aromatic ketone)s are generally known, with many examples being commercially available. Examples of commercially available poly(aromatic ketone)s include those sold under the trade name PEEK™, available from VICTREX.

In an aspect, the poly(aromatic ketone) comprises a poly(ether ketone), poly(ether ether ketone), poly(ether ketone ketone), or a combination thereof, preferably a poly(ether ether ketone) of formula (14).

The epoxy resin can be the result of the reaction of phenols or polyphenols with epichlorohydrin to form polyglycidyl ethers. Examples of useful phenols for production of epoxy resins include substituted bisphenol A, bisphenol F, hydroquinone, resorcinol, tris-(4-hydroxyphenyl)methane, and novolac resins derived from phenol or o-cresol. Epoxy resins can also be produced by reaction of aromatic amines, such as p-aminophenol or methylenedianiline, with epichlorohydrin to form polyglycidyl amines. In an aspect, the epoxy resin can comprise a novolac resin. In an aspect the epoxy resin can comprise a novolac resin derived from cresol.

The polyphenylene sulfide composition can comprise the polyetherimide-siloxane copolymer in an amount of 5 weight percent to 43.9 weight percent, based on the total weight of the composition. Within this range, the polyetherimide-siloxane copolymer can be present in an amount of 5 weight percent to 40 weight percent, or 5 weight percent to 30 weight percent, or 5 weight percent to 25 weight percent, or 10 weight percent to 20 weight percent, or 12 weight percent to 18 weight percent.

The polyphenylene sulfide composition can comprise the polyphenylene sulfide in an amount of 55 weight percent to 85 weight percent, based on the total weight of the composition. Within this range, the polyphenylene sulfide can be present in an amount of 60 weight percent to 85 weight percent, or 70 weight percent to 85 weight percent, or 72 weight percent to 85 weight percent, or 75 weight percent to 80 weight percent.

The polyphenylene sulfide composition can comprise the polyaromatic ketone in an amount of 1 weight percent to 10 weight percent, based on the total weight of the composition. Within this range, the polyaromatic ketone can be present in an amount of 1 weight percent to 8 weight percent, or 2 weight percent to 8 weight percent, or 3 weight percent to 7 weight percent, or 4 weight percent to 6 weight percent.

The polyphenylene sulfide composition can comprise the epoxy resin in an amount of 0.1 weight percent to 5 weight percent, based on the total weight of the composition. Within this range, the epoxy can be present in an amount of 0.1 weight percent to 4 weight percent, or 0.2 weight percent to 3 weight percent, or 0.5 weight percent to 3 weight percent, or 1 weight percent to 3 weight percent, or 1.5 weight percent to 2.5 weight percent.

The thermoplastic composition of the article, in addition to the thermoplastic polymer, can optionally further comprise one or more additives selected to achieve a desired property (e.g., improved adhesion, flowability, processability, miscibility, and the like), with the proviso that the additive(s) are also selected so as to not significantly adversely affect a desired property of the thermoplastic composition. The additive composition or individual additives can be mixed at a suitable time during the mixing of the components for forming the composition. The additive composition can include, for example, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer. UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. The additives can be used in amounts generally known to be effective. For example, the total amount of the additive composition (other than any impact modifier, filler, or reinforcing agent) can be 0.001 weight percent to 10 weight percent, or 0.01 weight percent to 5 weight percent, each based on the total weight of the composition. In an aspect, no additives are intentionally added to the thermoplastic composition of the article.

FIG. 1 shows a bottom view of an exemplary article (e.g., a retaining ring) (101) according to an aspect of the present disclosure. A bottom surface (102) of the article (101) can comprise a plurality of channels (103) in the bottom surface (102) extending from an inner edge (104) of the article to an outer edge (105) of the article. The channels can facilitate the transfer of the slurry in and out of the article during a polishing process. The depth of the channels can be modified (e.g., made deeper or shallower) to accommodate or modify the flow of fluid (polishing slurry or other liquid) into and out of the article, where the substrate is located. The channel cross section can have a rectangular shape, a radius shape, or any other suitable shape. The shape of the cross section of the channel can be chosen to reduce or eliminate low flow areas or dead volumes in the channels.

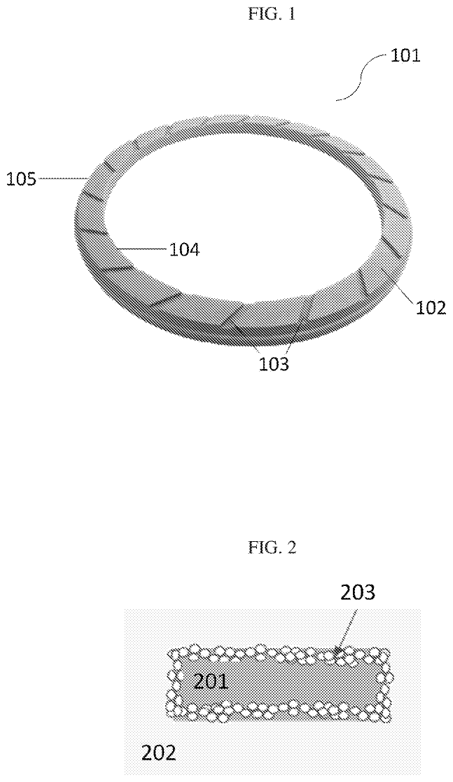

A cross-sectional view of an article according to an aspect of the present disclosure is shown in FIG. 2. As shown in FIG. 2, an article can comprise a metal backbone (201) comprising a plurality of pores (203) on the surface of the metal backbone. The metal backbone having a plurality of pores is encapsulated in a thermoplastic composition (202).

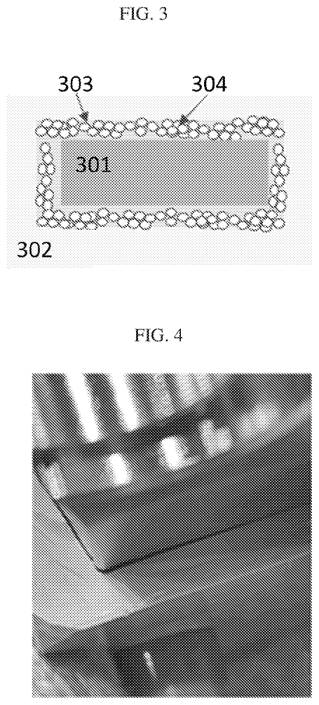

A cross-sectional view of an article according to another aspect of the present disclosure is shown in FIG. 3. As shown in FIG. 3, an article can comprise a metal backbone (301), with or without pores, comprising a buffer layer (303) on the surface (i.e., encapsulating) the metal backbone. The buffer layer (303) comprises a plurality of pores (304) on the surface of the buffer layer (303). The metal backbone (301) encapsulated in the buffer layer (303) is further encapsulated in a thermoplastic composition (302).

The article of the present disclosure can be made by a method comprising surface treating the metal backbone to provide a plurality of pores on the metal backbone. When a buffer layer is present on the article, the method comprises depositing the buffer layer on the metal backbone, and surface treating the buffer layer to provide the plurality of pores on the buffer layer. The method further comprises molding the thermoplastic composition over the metal backbone such that the metal backbone is encapsulated by the thermoplastic composition. When the buffer layer is present, the thermoplastic composition is molded over the metal backbone comprising the buffer layer.

The surface treating to provide the pores can include, for example, laser etching, chemical etching, plasma etching, or a combination thereof. In an aspect, the surface treating can comprise plasma etching.

In an aspect, the molding is by an overmolding process wherein the thermoplastic composition is molded in the presence of the metal backbone, optionally including the buffer layer. Stated another way, the thermoplastic composition can be formed or molded directly over or around the metal backbone, optionally including the buffer layer. This process can also be referred to as a metal insert molding process. Overmolding of the thermoplastic composition over the metal backbone can be by any molding technique suitable for melt processing thermoplastic compositions. Exemplary molding techniques can include injection molding, injection-compression molding, compression molding and the like. In an aspect, the molding can be by injection molding the thermoplastic composition.

The method can further comprise creating a plurality of channels in the bottom surface of the article. The plurality of channels can be as shown in FIG. 1.

The article of the present disclosure can be particularly useful in a chemical mechanical polishing system. Thus, another aspect of the present disclosure is a chemical mechanical polishing system comprising the above-described article. In a specific aspect, a chemical mechanical polishing system comprises the above-described article, wherein the article is a retaining ring.

Another aspect of the present disclosure is a polyphenylene sulfide composition, independent of its use as a component of an article for use in a chemical mechanical polishing process. The polyphenylene sulfide composition is as described above and comprises the polyetherimide-siloxane copolymer, the polyphenylene sulfide, the polyaromatic ketone, and the epoxy resin.

The polyphenylene sulfide composition can comprise the polyetherimide-siloxane copolymer in an amount of 5 weight percent to 43.9 weight percent, based on the total weight of the composition. Within this range, the polyetherimide siloxane copolymer can be present in an amount of 5 weight percent to 40 weight percent, or 5 weight percent to 30 weight percent, or 5 weight percent to 25 weight percent, or 10 weight percent to 20 weight percent, or 12 weight percent to 18 weight percent.

The polyphenylene sulfide composition can comprise the polyphenylene sulfide in an amount of 55 weight percent to 85 weight percent, based on the total weight of the composition. Within this range, the polyphenylene sulfide can be present in an amount of 60 weight percent to 85 weight percent, or 70 weight percent to 85 weight percent, or 72 weight percent to 85 weight percent, or 75 weight percent to 80 weight percent.

The polyphenylene sulfide composition can comprise the polyaromatic ketone in an amount of 1 weight percent to 10 weight percent, based on the total weight of the composition. Within this range, the polyaromatic ketone can be present in an amount of 1 weight percent to 8 weight percent, or 2 weight percent to 8 weight percent, or 3 weight percent to 7 weight percent, or 4 weight percent to 6 weight percent.

The polyphenylene sulfide composition can comprise the epoxy in an amount of 0.1 weight percent to 5 weight percent, based on the total weight of the composition. Within this range, the epoxy can be present in an amount of 0.1 weight percent to 4 weight percent, or 0.2 weight percent to 3 weight percent, or 0.5 weight percent to 3 weight percent, or 1 weight percent to 3 weight percent, or 1.5 weight percent to 2.5 weight percent.

The polyphenylene sulfide composition can optionally further comprise one or more additives selected to achieve a desired property (e.g., improved adhesion, flowability, processability, miscibility, and the like), with the proviso that the additive(s) are also selected so as to not significantly adversely affect a desired property of the thermoplastic composition. The additive composition or individual additives can be mixed at a suitable time during the mixing of the components for forming the composition. The additive composition can include, for example, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. The additives can be used in amounts generally known to be effective. For example, the total amount of the additive composition (other than any impact modifier, filler, or reinforcing agent) can be 0.001 weight percent to 10 weight percent, or 0.01 weight percent to 5 weight percent, each based on the total weight of the composition.

Other components not specifically provided for herein can be minimized or excluded from the composition. For example, the polyphenylene sulfide composition can minimize (e.g., present in an amount of less than 5 weight percent, or less than 1 weight percent, or less than 0.1 weight percent) thermoplastic polymers other that the polyetherimide-siloxane copolymer, the poly(phenylene sulfide), and the polyaromatic ketone.

This disclosure is further illustrated by the following examples, which are non-limiting.

### EXAMPLES

Materials used in the following examples are summarized in Table 1.

TABLE 1

| Component | Description | Supplier |
|---|---|---|
| PPS-1 | Polyphenylene sulfide, extrusion grade, having a melt flow index of 80 grams | Zhejiang NHU |
| | per 10 minutes according to ISO1133 at 316° C. and 5 kg, obtained as NHU | Co., Ltd. |
| | 3508 | |
| PEI | Polyetherimide comprising structural units derived from meta-phenylene | SABIC |
| | diamine and bisphenol A dianhydride, phthalic anhydride end-capped, with a | |
| | melt flow rate of about 18 grams per 10 minutes measured at 337° C. and | |
| | 6.6 kgf, available as ULTEM 1010 | |
| PEEK | Polyether ether ketone obtained as VICTREX PEEK 90P | Solvay |
| PEI-Si | Polyetherimide-polysiloxane block copolymer having a siloxane content of 20 | SABIC |
| | weight percent, with a melt flow rate of about 65 grams per 10 minutes | |
| | measured at 337° C. and 6.6 kgf, available as SILTEM 1700 | |
| Epoxy | Epoxy cresol novolac resin with an epoxide equivalent weight of 217-244 g/eq, | Huntsman |
| | and an epoxy functionality of about 5.4, obtained as ECN1299 | |
| PBN | Polybutylene naphthalate, obtained as TQB-OT | Teijin |
| | | Chemicals, Ltd. |

Table 2 summarizes the composition of the test samples for the following examples. The amount of each component is provided in weight percent based on the total weight of the composition.

TABLE 2

Thermoplastic Composition

| Component | A | B | C | D | E |
|---|---|---|---|---|---|
| PPS-1 | 100 | | 78 | | |
| PEI | | 100 | | | |
| PEEK | | | 5 | 100 | |
| PEI-Si | | | 15 | | |
| Epoxy | | | 2 | | |
| PBN | | | | | 100 |

Physical properties were characterized according to the following test procedures.

Adhesion strength (“As”) was determined according to ASTM 1002 and measured on a sample prepared from a molded sample of the composition bonded to aluminum having dimensions of 18×50×1.5 mm, with a bonding area of 10×5 mm. Adhesion strength is reported in MPa. It is noted that the test article used to evaluate adhesion strength was not in the forming of a CMP retaining ring. Adhesion strength was independently tested because, without wishing to be bound by theory, it is believed that the adhesion strength exhibited by the test article can give an indication of whether a composition may be successful when used as a CMP retaining ring.

The following tests were conducted on a CMP retaining ring article wherein the thermoplastic composition was overmolded onto the metal ring. Flatness (“Fn”) was determined by measuring the thickness of a molded sample in the form of a retaining ring at nine points across the sample. The flatness was taken as the average of the standard deviation across the nine thicknesses. Distortion (“Dt”) was characterized by measuring the flatness of a molded sample in the form of a retaining ring and was given a rating of “fail” if the flatness value was greater than 0.01 millimeters (mm), and a rating of “pass” if the flatness value was less than or equal to 0.01 mm.

Results are summarized in Tables 3A and 3B. The insert metal used with stainless steel (SUS304) or an Al—Zn alloy. Where indicated in the Table, an Al₂O₃ buffer layer was deposited on the insert metal by plasma etching. Where indicated in the Table, a plasma etching process was used to introduce nanopores into the insert metal or the buffer layer.

TABLE 3A

| Example | CE1 | CE2 | CE3 | CE4 | CE5 | CE6 | CE7 | CE8 | E1 |
|---|---|---|---|---|---|---|---|---|---|
| Therm. | A | A | A | A | A | A | B | B | B |
| composition | | | | | | | | | |
| Insert metal | SUS304 | Al—Zn | SUS304 | Al—Zn | SUS304 | Al—Zn | SUS304 | Al—Zn | SUS304 |
| Nanopore on | — | — | | | yes | yes | — | — | |
| metal | | | | | | | | | |
| Nanopore w/ | — | — | yes | yes | | | — | — | yes |
| buffer | | | | | | | | | |
| As | — * | — * | — * | — * | — * | — * | 2.2 | 2.3 | 2.3 |
| Fa (avg, mm) | 0.015 | 0.0016 | — * | — * | — * | — * | 0.012 | 0.012 | 0.005 |
| Dt | Fail | Fail | — * | — * | — * | — * | Fail | Fail | Pass |
| Example | E2 | E3 | E4 | E5 | E6 | E7 | E8 | E9 | E10 |
| Therm. | B | B | B | C | C | C | C | C | C |
| composition | | | | | | | | | |
| Insert metal | Al—Zn | SUS304 | Al—Zn | SUS304 | Al—Zn | SUS304 | Al—Zn | SUS304 | Al—Zn |
| Nanopore on | | yes | yes | — | — | | | yes | yes |
| metal | | | | | | | | | |
| Nanopore w/ | yes | | | — | — | yes | yes | | |
| buffer | | | | | | | | | |
| As | 2.2 | 2.3 | 2.3 | 32 | 31 | 34 | 33 | 37 | 37 |
| Fa (avg, mm) | 0.006 | 0.005 | 0.006 | 0.003 | 0.004 | 0.002 | 0.003 | 0.001 | 0.002 |
| Dt | Pass | Pass | Pass | Pass | Pass | Pass | Pass | Pass | Pass |

* cannot be measured

TABLE 3B

| Example | CE11 | CE12 | E11 | E12 | E13 | E14 | CE13 | CE14 | E15 | E15 | E17 | E18 |
|---|---|---|---|---|---|---|---|---|---|---|---|---|
| Therm. | D | D | D | D | D | D | E | E | E | E | E | E |
| composition | | | | | | | | | | | | |
| Insert metal | SUS304 | Al—Zn | SUS304 | Al—Zn | SUS304 | Al—Zn | SUS304 | Al—Zn | SUS304 | Al—Zn | SUS304 | Al—Zn |
| Nanopore on metal | — | — | | | yes | yes | — | — | | | yes | yes |
| Nanopore w/buffer | — | — | yes | yes | | | — | — | yes | yes | | |
| As | 28 | 27 | 29 | 29 | 30 | 30 | 29 | 30 | 30 | 31 | 32 | 33 |
| Fn (avg, mm) | 0.011 | 0.009 | 0.008 | 0.009 | 0.009 | 0.009 | 0.012 | 0.011 | 0.008 | 0.009 | 0.008 | 0.008 |
| Dt | Fail | Pass | Pass | Pass | Pass | Pass | Fail | Fail | Pass | Pass | Pass | Pass |

As shown in Tables 3A and 3B, the test samples prepared from the thermoplastic compositions B-E were observed to provide improved adhesion strength between the metal and the thermoplastic. In contrast, the adhesion strength between the metal and thermoplastic composition A could not be measured. As noted above, the adhesion strength of the test articles may provide an indication as to the utility of the composition in CMP applications.

Samples including nanopores (E1-E18) exhibited significantly lower flatness compared to samples lacking the nanopores (e.g., 0.001 to 0.009 for E1-E18, compared to 0.009 or greater for comparative examples). Without wishing to be bound by theory, it is believed that improved flatness may arise from the ability of the thermoplastic composition to fill the nanopores on the metal ring or the buffer layer, when present. The materials can therefore become interlocked due to the pore filling, leading to improved flatness of the article.

Tables 3A and 3B further show that samples including the nanopores were not distorted. In contrast, the comparative examples not including the nanopores generally exhibited more significant distortion.

The CMP retaining ring samples were further characterized for delamination of the thermoplastic composition from the metal ring. Delamination was determined by visually inspecting a cross section of the retainer ring product after cutting the product open. Upon inspection of the cut samples, it was noted that the samples prepared from the thermoplastic composition A exhibited delamination. In contrast, it was noted that none of the samples using the thermoplastic compositions C-E exhibited any delamination. While the examples using the thermoplastic composition B were observed to exhibit some delamination, performance of the article was not significantly affected, likely due to the flatness of the article and the lack of distortion.

It was further unexpectedly noted that the particular thermoplastic composition C provided good adhesion, flatness and distortion even in the absence of the nanopores, suggesting that this composition may be particularly useful in CMP retaining ring articles even in the absence of nanopores.

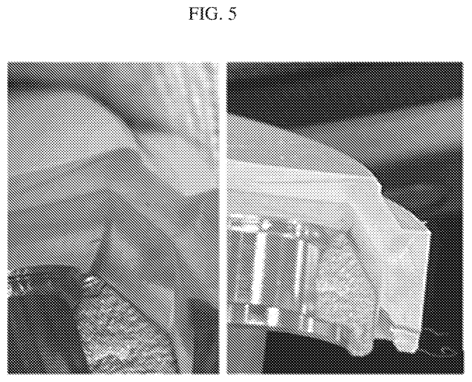

As shown in FIG. 4, the composition of CE1 exhibited delamination of the thermoplastic composition from the metal insert upon inspection of the cross section of the ring after cutting. In contrast, as shown in FIG. 5, no delamination was observed for the composition of E5 upon inspection of the cross section of the ring after cutting.

The composition of E5 was further observed to provide good color uniformity on the surface, and the compositions of both E1 and E5 exhibited good color uniformity between the inside and an outer layer of a molded part. These compositions were further found to have good processability, particularly with respect to cutting, slicing, bolting, and tapping, and did not exhibit any cracking or chipping after aging or during processing. Further advantages of the present disclosure include reduced part dimensions (e.g., thickness, height, weight), and improved strength of the retaining ring structure.

A significant advantage has therefore been provided for articles for chemical mechanical polishing processes where good processability and strong adhesion to metal are needed.

This disclosure further encompasses the following aspects.

Aspect 1: An article for use in a chemical mechanical polishing process comprising: a metal backbone optionally comprising a buffer layer on a surface of the metal backbone, wherein the metal backbone further comprises a plurality of pores on the surface of the metal backbone or, when present, on the buffer layer; and a thermoplastic composition encapsulating the metal backbone.

Aspect 2: The article of aspect 1, wherein the thermoplastic composition comprises a polyetherimide, a poly(phenylene sulfide), a poly(phenylene sulfone), a poly(aromatic ketone), a polyester, or a combination thereof.

Aspect 3: The article of aspect 1 or 2, wherein the thermoplastic composition comprises a polyetherimide.

Aspect 4: The article of aspect 3, wherein the polyetherimide comprises repeating units derived from meta-phenylene diamine and bisphenol A dianhydride.

Aspect 5: The article of aspect 3, wherein the polyetherimide is a poly(etherimide-siloxane) block copolymer.

Aspect 6: The article of any of aspects 1 to 5, wherein the thermoplastic composition comprises: 5 to 43.9 weight percent of a poly(etherimide-siloxane copolymer); 55 to 85 weight percent of a poly(phenylene sulfide); 1 to 10 weight percent of a polyaryl ether ketone; and 0.1 to 5 weight percent of an epoxy resin; wherein weight percent is based on the total weight of the thermoplastic composition.

Aspect 7: The article of any of aspects 1 to 6, wherein the plurality of pores are on the surface of the metal backbone, preferably wherein the metal backbone comprises aluminum, stainless steel, molybdenum, a ceramic, or a combination thereof.

Aspect 8: The article of any of aspects 1 to 6, wherein the buffer layer is present and the plurality of pores are on the buffer layer.

Aspect 9: The article of any of aspects 1 to 8, wherein each of the plurality of pores has a diameter of 1 nanometer to 100 nanometers, preferably wherein each of the plurality of pores further has a depth of 1 nanometer to 100 nanometers.

Aspect 10: The article of any of aspects 1 to 9, wherein the buffer layer comprises an inorganic, an organic material, or a combination thereof, preferably wherein the buffer layer comprises Al₂O₃, TiO₂, ZnO, SiO₂, PbO, Na₂O, CaO, MgO, CuO, or an alloy thereof, more preferably Al₂O₃.

Aspect 11: The article of any of aspects 1 to 10, wherein the buffer layer has a thickness of 1 micrometer to 1000 micrometers.

Aspect 12: The article of any of aspects 1 to 10, wherein a bottom surface of the article comprises a plurality of channels in the bottom surface extending from an inner edge of the article to an outer edge of the article, wherein the channels are effective to transfer a slurry during a polishing process.

Aspect 13: The article of any of aspects 1 to 12, wherein the metal backbone is an annular metal backbone.

Aspect 14: The article of any of aspects 1 to 11, wherein the article is a retaining ring for use in a chemical mechanical polishing process.

Aspect 15: A method of manufacturing the article of any of aspects 1 to 14, the method comprising: providing a metal backbone; optionally, depositing a buffer layer on the metal backbone; surface treating the metal backbone or, when present, the buffer layer, to provide a plurality of pores on the metal backbone or, when present, the buffer layer; and molding a thermoplastic composition onto the surface treated metal backbone to provide the article.

Aspect 16: A chemical mechanical polishing system comprising the article of any of aspects 1 to 14.

Aspect 17: A polyphenylene sulfide composition comprising: 5 to 43.9 weight percent of a poly(etherimide-siloxane copolymer); 55 to 85 weight percent of a poly(phenylene sulfide); 1 to 10 weight percent of a polyaryl ether ketone; and 0.1 to 5 weight percent of an epoxy resin; and optionally, 0.1 to 10 weight percent of an additive composition; wherein weight percent is based on the total weight of the thermoplastic composition.

Aspect 18: An article for use in a chemical mechanical polishing process comprising: a metal backbone optionally comprising a buffer layer on a surface of the metal backbone; and a thermoplastic composition encapsulating the metal backbone; wherein the thermoplastic composition comprises 5 to 43.9 weight percent of a poly(etherimide-siloxane copolymer); 55 to 85 weight percent of a poly(phenylene sulfide); 1 to 10 weight percent of a polyaryl ether ketone; and 0.1 to 5 weight percent of an epoxy resin; and optionally, 0.1 to 10 weight percent of an additive composition; wherein weight percent is based on the total weight of the thermoplastic composition.

Aspect 19: The article of aspect 18, wherein the metal backbone further comprises a plurality of pores on the surface of the metal backbone or, when present, on the buffer layer.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first.” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₁₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An article for use in a chemical mechanical polishing process comprising:
a metal backbone optionally comprising a buffer layer on a surface of the metal backbone, wherein the metal backbone further comprises a plurality of pores on the surface of the metal backbone or, when present, on the buffer layer; and
a thermoplastic composition encapsulating the metal backbone.

2. The article of claim 1, wherein the thermoplastic composition comprises a polyetherimide, a poly(phenylene sulfide), a poly(phenylene sulfone), a poly(aromatic ketone), a polyester, or a combination thereof.

3. The article of claim 1, wherein the thermoplastic composition comprises a polyetherimide.

4. The article of claim 3, wherein the polyetherimide is a poly(etherimide-siloxane) block copolymer.

5. The article of claim 1, wherein the thermoplastic composition comprises:
5 to 43.9 weight percent of a poly(etherimide-siloxane copolymer);
55 to 85 weight percent of a poly(phenylene sulfide);
1 to 10 weight percent of a polyaryl ether ketone; and
0.1 to 5 weight percent of an epoxy resin;
wherein weight percent is based on the total weight of the thermoplastic composition.

6. The article of claim 1, wherein the plurality of pores are on the surface of the metal backbone.

7. The article of claim 1, wherein the buffer layer is present and the plurality of pores are on the buffer layer.

8. The article of claim 1, wherein each of the plurality of pores has a diameter of 1 nanometer to 100 nanometers.

9. The article of claim 1, wherein the buffer layer comprises an inorganic, an organic material, or a combination thereof.

10. The article of claim 1, wherein a bottom surface of the article comprises a plurality of channels in the bottom surface extending from an inner edge of the article to an outer edge of the article, wherein the channels are effective to transfer a slurry during a polishing process.

11. The article of claim 1, wherein the metal backbone is an annular metal backbone.

12. The article of claim 1, wherein the article is a retaining ring for use in a chemical mechanical polishing process.

13. A method of manufacturing the article of claim 1, the method comprising:
providing a metal backbone;
optionally, depositing a buffer layer on the metal backbone;
surface treating the metal backbone or, when present, the buffer layer, to provide a plurality of pores on the metal backbone or, when present, the buffer layer; and
molding a thermoplastic composition onto the surface treated metal backbone to provide the article.

14. A chemical mechanical polishing system comprising the article of claim 1.

15. A polyphenylene sulfide composition comprising:
5 to 43.9 weight percent of a poly(etherimide-siloxane copolymer);
55 to 85 weight percent of a poly(phenylene sulfide);
1 to 10 weight percent of a polyaryl ether ketone; and
0.1 to 5 weight percent of an epoxy resin; and
optionally, 0.1 to 10 weight percent of an additive composition;
wherein weight percent is based on the total weight of the thermoplastic composition.

16. The article of claim 1, wherein the thermoplastic composition comprises a polyetherimide comprising repeating units derived from meta-phenylene diamine and bisphenol A dianhydride.

17. The article of claim 1, wherein the metal backbone comprises aluminum, stainless steel, molybdenum, a ceramic, or a combination thereof.

18. The article of claim 1, wherein the buffer layer comprises Al₂O₃, TiO₂, ZnO, SiO₂, PbO, Na₂O, CaO, MgO, CuO, or an alloy thereof.

19. The article of claim 1, wherein the buffer layer has a thickness of 1 micrometer to 1000 micrometers.
